(19) United States
(12) Patent Application Publication
(10) Pub. No.: US 2026/0140033 A1
(43) Pub. Date: May 21, 2026

(54) IN-SITU DETECTION SYSTEM INVOLVING MULTI MEASUREMENTS COUPLING WITH NUCLEATION REACTOR

(71) Applicants: Beijing University of Chemical Technology, Beijing (CN); Quzhou Resource and Chemical Innovation Research Institute, Quzhou (CN)

(72) Inventors: Yanan LIU, Beijing (CN); Songyu NIU, Beijing (CN); Jingyu LI, Beijing (CN); Dianqing LI, Beijing (CN); Yanjun LIN, Beijing (CN); Jingbin HAN, Beijing (CN); Xue DUAN, Beijing (CN)

(73) Assignees: Beijing University of Chemical Technology, Beijing (CN); Quzhou Resource and Chemical Innovation Research Institute, Quzhou (CN)

(21) Appl. No.: 19/205,022

(22) Filed: May 12, 2025

(30) Foreign Application Priority Data
Nov. 19, 2024 (CN) 202411657126.6
Feb. 21, 2025 (CN) 202510197829.3

(51) Int. Cl. G01N 15/0227; G01N 15/00; G01N 15/14; G01N 15/1409; G01N 15/1434

(52) U.S. Cl. CPC G01N 15/0227; G01N 15/1409; G01N 15/1434; G01N 2015/0038; G01N 2015/1493

(57) ABSTRACT

An in-situ detection system involving multi measurements coupling with a nucleation reactor includes a crystal nucleus transient evolution imaging system and a time-resolved detection system which are in-situ connected with a rotating micro-liquid film reactor. A micro negative pressure sampler is made to capture nucleation particles in high-speed shear field and enter the visible observation area. The sampler is in-situ connected with a high-speed camera and microscope objective to obtain instantaneous images of the nucleation process at the nanoscale and in-situ capture the transient evolution behavior of crystal nuclei. The sampler is used for capturing nucleation particles in a high-speed shear field, and is connected to a flow-through cell. The time-resolved detection system for microsecond full spectrum acquisition with in-situ coupling of nucleation reactors is constructed using a CMOS detector with large-diameter optical fiber, high-power light source, and fast acquisition rate, and low integration time fiber spectrometer.

### CROSS-REFERENCE TO RELATED APPLICATIONS

This application claims priority to Chinese Patent Application No. 202411657126.6, filed on Nov. 19, 2024, and Chinese Patent Application No. 202510197829.3, filed on Feb. 21, 2025. All of the aforementioned applications are incorporated herein by reference in their entireties.

### TECHNICAL FIELD

The present disclosure relates to an in-situ detection system involving multi measurements coupling with a nucleation reactor, comprising a crystal nucleus transient evolution imaging system and a time-resolved detection system which are in-situ connected with a rotating micro-liquid film reactor. Specifically, it relates to a high-speed imaging system for monitoring a nucleation behavior of nanomaterials in a rotating liquid film reactor and a time-resolved detection system for capturing the coordination structure of nucleation particles and the dynamic evolution behavior of intermediate species.

### BACKGROUND

Inorganic nano-materials are widely used in fields such as chemical engineering, catalysis, agriculture, construction, and rubber processing, with direct and indirect economic benefits amounting to billions. Among them, precipitation reaction is usually used to prepare inorganic nanomaterials. However, due to the poor structure and micro mixing effect of traditional stirred tank reactors, the nucleation and growth of inorganic nanomaterials are uncontrollable, resulting in poor quality of large-scale preparation and affecting the application performance of inorganic nanomaterials. Beijing University of Chemical Technology has invented a rotating liquid film reactor with forced micro mixing effect that can be used for liquid-phase precipitation reactions. The reactor consists of a rotor and a stator, in the initial stage of precipitation reaction, a huge reaction driving force is generated due to the high degree of supersaturation.

After the precipitation reaction begins, a strong shear field is formed between the rotor and stator, which can promote micro mixing and mass transfer effectively, and form a large number of crystal nuclei sustainably, rapidly and quickly, achieving the separation of nucleation and crystallization processes, thereby significantly reducing the particle size of the generated precipitate, narrowing the particle size distribution range, and improving the application performance of the precipitate as a functional material. However, the nucleation mechanism is not yet clear.

The airtightness of the rotating liquid film reactor leads to the offline observation of precipitation products, which makes it difficult to quickly and accurately capture instantaneous processes such as nucleation and phase transition without damaging the strong shear field. Meanwhile, the nucleation process of nanomaterials usually occurs in a very short period of time and involves complex chemical changes. UV visible absorption spectroscopy can obtain information such as size and coordination structure by utilizing the transitions of valence electrons in molecules or ions of a substance to absorb UV and visible light to varying degrees. However, at the time scale, the time resolution for collecting the full spectrum within a certain wavelength range of current instruments only reach the second level, which limits the exploration of the nucleation mechanism of nanomaterials with uniform particle size distribution prepared by rotating liquid film reactors.

### SUMMARY

The present disclosure relates to an in-situ detection system involving multi measurements coupling with a nucleation reactor, comprising either one or both of a crystal nucleus transient evolution imaging system and a time-resolved detection system. Especially involving a high-speed imaging system for monitoring a nucleation behavior of nanomaterials in a rotating liquid film reactor and a time-resolved detection system for capturing the coordination structure of nucleation particles and the dynamic evolution behavior of intermediate species.

Both high-speed imaging system and time-resolved detection system include a rotating micro liquid film reactor, which is composed of a closed casing as a stator; the upper end of the stator is filled with reaction solutions according to the stoichiometric ratio; there is a rotatable rotor inside the stator, which forms a narrow slit with the stator with the width being 10˜500 μm; a shear field is formed between the rotor and stator; the internal cavity of the stator is a circular cone with a narrow upper and wide lower structure, with a trapezoidal cross-section and a trapezoidal bottom angle design of 70˜85°; the stator height is 60˜80 mm, which could be moved up and down (Δh) to adjust the slit width; the rotor and stator structure are matched to maintain parallel sides when adjusting Δh; a hole that can connect to the motor shaft is set at the axial center to drive rotate at high speed once connecting to the electrode.

Furthermore, the rotor speed is 500˜5000 rpm; the stator cavity is a truncated and hollow cone with a narrow upper and wide lower structure with the top diameter of 42.3 mm, the bottom diameter of 51.5 mm, and the height of 75 mm; the cross section is trapezoidal, and the trapezoidal bottom angle is designed to be 85°; set 8 sampling ports every 6 mm at a distance of 30 mm from the top of the stator.

The high-speed imaging system for monitoring a nucleation behavior of nanomaterials is equipped with a sampling port on one side of the stator sidewall of the rotating micro-liquid film reactor; a sampler is made to capture nucleation particles in the shear field and enter the visible observation area; open a viewing window on the other side of the stator sidewall; a high-speed camera with microscope lens is installed in the visual observation area or open window; a light source is installed on the opposite side of the high-speed camera, and the high-speed camera is connected to the computer to obtain the data.

Moreover, the visible observation area is composed of two parallel stacked glass sheets with a thickness of 1˜3 mm, and there are micro scale channels with different shapes and diameters of 50˜100 μm between the two glass sheets; the glass material is one of polydimethylsiloxane, borosilicate, polystyrene, and polyurethane.

The visible observation area is equipped with a vertical lifting platform, which could adjust the height; the high-speed camera records the images at a speed of 10000˜12000 frames per second, and is connected to a microscope lens with a magnification of 10˜50 times; the light source is white LED, a red LED, green LED, or a pulsed laser.

The time-resolved detection system for capturing the coordination structure of nucleation particles and the dynamic evolution behavior of intermediate species comprises a light source, an in-situ flow cell, optical fiber, vacuum sampler, optical fiber spectrometer, signal control and acquisition device.

The sampling port of the rotating liquid film reactor is connected in situ to the flow cell; the upper end of the in-situ flow cell is connected to a light source through a fiber optic cable, and the lower end is connected to a fiber optic spectrometer, achieving the construction of time-resolved in-situ spectra with a resolution of less than 500 μs; metal salt solution and alkali solution are added into a rotating liquid film reactor for nucleation, and the nucleation slurry is captured into an in-situ flow cell through a vacuum sampler, and obtain the changes of coordination structure during the nucleation process through collecting a time-resolved spectrum of less than 500 μs; there is a convex lens at each end of the in-situ flow cell to form a symmetrical optical path.

The inlet is located at the top of the in-situ flow cell, and the outlet is at the bottom of it; The material of in-situ flow cell is one of borosilicate glass, quartz glass, or polymethyl methacrylate, with the light transmittance of over 92%; The focal length of the convex lens is 20 mm, and the clear aperture is 10 mm; The core diameter of the connecting fiber is 400˜600 μm, and the band is 200˜1200 nm; The light source with power 40˜400 W is one of xenon lamp, deuterium lamp, deuterium halogen lamp, or halogen lamp.

The fiber optic spectrometer has a CMOS detector with an integration time of less than 300 μs.

The molar concentration ratio of the metal salt solution to the alkali solution is 1/1˜3; The concentration of the nucleation slurry is 0.005˜0.01 mol/L; The flow rate of the nucleation slurry entering the in-situ flow cell is 50-80 mL/min.

The application of an in-situ detection system involving multi measurements coupling with a nucleation reactor is used for in-situ capturing the coordination structure, particle size, and dynamic behavior of reaction intermediates of nanoparticles in rotating liquid film reactor. The nanoparticles include hydrotalcite, oxide, hydroxide, pseudo boehmite, and barium sulfate.

The present disclosure has the beneficial effects: provides an in-situ detection system involving multi measurements coupling with nucleation reactor, comprising either one or both of a crystal nucleus transient evolution imaging system and a time-resolved detection system.

Firstly, starting from the basic process of preparing metal hydroxides by precipitation method, the fluid mixing process of the rotating liquid film reactor was simulated by computational fluid dynamics (CFD). The bottom angle of the truncated cone stator of the rotating liquid film reactor was set to 70˜85°, the rotation speed was set to 500˜5000 rpm, and the slit width was set to 10˜500 μm, ensuring that the fluid did not mix back through the slit and forming a strong shear field between the rotor and stator. Nucleation particles were captured within high-speed shear field into the visible observation area through micro negative pressure sampler; The sampler is in-situ coupled with high-speed cameras and microscope objectives, which can in-situ monitor the nucleation process at the nano/micro scale, capture the transient evolution behavior of crystal nuclei, and establish a nucleation/crystallization kinetics.

Furthermore, the spectral acquisition speed was improved by using a fiber optic spectrometer with a CMOS detector, and the time resolution of the full spectrum (in the 200˜1200 nm) was increased to the level of microseconds (<500 μs). Then, the time-resolved detection system was coupled with a rotating liquid film reactor to in-situ capture the dynamic changes in the rapid nucleation process, and thereby obtain the coordination structure of reactants and the evolution trend of intermediate species during the nucleation process in different shear regions of the rotating liquid film reactor.

The construction of an in-situ detection system involving multi measurements coupling with a nucleation reactor has solved the problems of poor structure and micro mixing effect of traditional stirred tank reactors, uncontrollable nucleation and growth, poor quality of large-scale preparation, and inability to observe phase transition and nucleation instantaneous processes in closed reactors. The obtained nucleation results enrich the non-classical nucleation theory, provide guidance for the large-scale preparation of nanomaterials, and lay the foundation for a deeper understanding of the nucleation mechanism of nanoparticles and the derivation of nucleation mechanisms.

### BRIEF DESCRIPTION OF THE DRAWINGS

FIG. 1 shows the overall composition diagram of a high-speed imaging system for monitoring a nucleation behavior of nanomaterials in a rotating liquid film reactor.

FIG. 2 shows the three-dimensional design of the rotor-stator and the visible observation area.

FIG. 3 shows the cross-sectional design of the stator of a rotating liquid film reactor, with a bottom angle of 85°.

FIG. 4 shows a schematic diagram of the gap between the rotor-stator slit, where Δh is the height of the stator rising.

FIG. 5 shows a schematic diagram of 8 sampling ports and windows set every 6 mm at a distance of 30 mm from the top of the stator on the side of the reactor in Example 1.

FIG. 6 shows a schematic diagram of the high-speed camera connected to the objective lens in Example 1.

FIG. 7 shows a schematic diagram of a time-resolved detection system for capturing the coordination structure of nucleation particles and the dynamic evolution behavior of intermediate species.

FIG. 8 shows the microsecond time-resolved UV visible spectra obtained from different sampling ports.

FIG. 9 shows the UV visible spectrum of sampling port 1 obtained by testing a halogen light source with a trial power of 400 W, as described in Example 11.

FIG. 10 shows the UV visible spectrum of sampling port 1 obtained from testing with a 50 μm core diameter fiber as described in Comparative Example 1.

FIG. 11 shows the UV visible spectrum of sampling port 1 obtained when the flow rate of the nucleating slurry entering the flow cell was increased to 80 mL/min as described in Comparative Example 2.

### DETAILED DESCRIPTION OF THE EMBODIMENTS

### Example 1

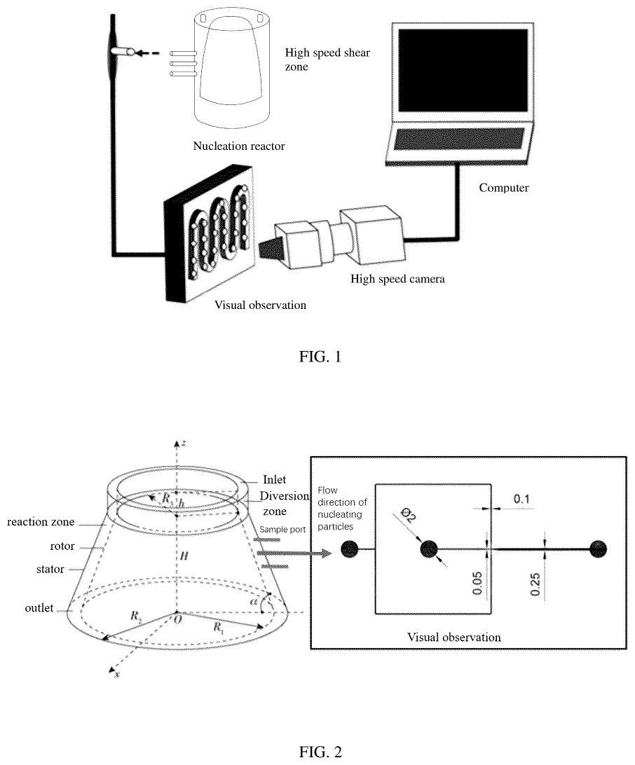

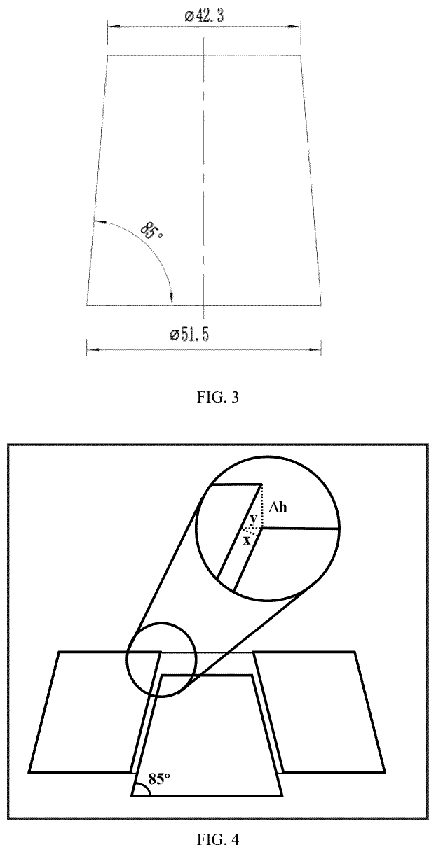

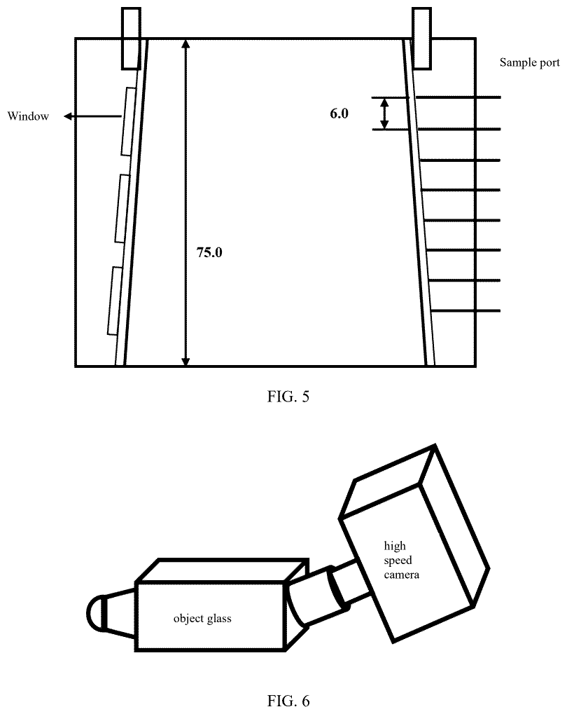

A high-speed imaging system for monitoring a nucleation behavior of nanomaterials in a rotating liquid film reactor, as shown in FIG. 1, consists of a closed casing and a truncated cone with a narrow upper and wide lower structure and a bottom angle of 85° as the stator. The upper of the stator can be added with reactants according to the stoichiometric ratio, and there is a rotatable conical rotor inside the stator, which is connected to a motor below; At a speed of 1500 rpm and a slit width of 200 μm, a strong shear field is formed between the rotor and stator; At a distance of 30 mm from the top of the stator in the axial direction of the rotor-stator group, 8 sampling ports are set every 6 mm, and a micro negative pressure sampler is made to capture nucleation particles in a high-speed shear field into a visible observation area with a thickness of 2 mm, composed of polydimethylsiloxane glass, and a channel diameter of 50 μm in a methyl cross shape. The height is adjusted by a vertical lifting platform; Open a viewing window 2 with a diameter of 10 mm and a thickness of 1 mm on the other side of the rotor stator assembly. A high-speed camera (recording speed of 12000 frames per second) is connected in situ to a coupled microscope objective (10×) in two types of visual observation areas, with an LED white light source on the opposite side of the high-speed camera. Further connect it with a computer to drive the high-speed camera and the rotating liquid film reactor to work simultaneously.

The high-speed imaging system used to monitor the nucleation behavior of nanomaterials in a rotating liquid film reactor is applied to the preparation of cobalt based layer double hydroxides (LDHs), and the specific operation is as follows:

Prepare a mixed nitrate solution with Co(NO₃)₂ and Al(NO₃)₃ in a molar ratio of Co²⁺/Al³⁺ of 2, where [M²⁺]=1.2 mol/L; Prepare NaOH solution in a ratio of n(NaOH)/[n(Co²⁺)+n(Al³⁺)]=1.8 Inject the mixed salt solution and alkali solution simultaneously into a rotating liquid film reactor for rapid nucleation. Capture the nucleation particles into the visible observation area through the first sampling port on the side of the reactor from the top of the stator in a high-speed shear field using a micro negative pressure sampler. By capturing images with a high-speed camera at a recording speed of 12000 frames per second, it is possible to observe in situ the formation of bubbles in the nucleation slurry. Different regions with rich and low solute content can be observed in the bubbles, which undergo phase separation to form solute rich regions, resulting in amorphous aggregates with a particle size of 1 μm. The results indicate that cobalt based LDHs conform to the two-step nucleation theory.

### Example 2

A high-speed imaging system for monitoring a nucleation behavior of nanomaterials in a rotating liquid film reactor, as shown in FIG. 1, consists of a closed casing and a truncated cone with a narrow upper and wide lower structure and a bottom angle of 85° as the stator. The upper of the stator can be added with reactants according to the stoichiometric ratio, and there is a rotatable conical rotor inside the stator, which is connected to a motor below; At a speed of 1500 rpm and a slit width of 200 μm, a strong shear field is formed between the rotor and stator; At a distance of 30 mm from the top of the stator in the axial direction of the rotor-stator group, 8 sampling ports are set every 6 mm, and a micro negative pressure sampler is made to capture nucleation particles in a high-speed shear field into a visible observation area with a thickness of 2 mm, composed of polydimethylsiloxane glass, and a channel diameter of 50 μm in a methyl cross shape. The height is adjusted by a vertical lifting platform; Open a viewing window 2 with a diameter of 10 mm and a thickness of 1 mm on the other side of the rotor stator assembly. A high-speed camera (recording speed of 12000 frames per second) is connected in situ to a coupled microscope objective (10×) in two types of visual observation areas, with an LED white light source on the opposite side of the high-speed camera. Further connect it with a computer to drive the high-speed camera and the rotating liquid film reactor to work simultaneously.

The high-speed imaging system used to monitor the nucleation behavior of nanomaterials in a rotating liquid film reactor is applied to the preparation of cobalt based LDHs, and the specific operation is as follows:

Prepare a mixed nitrate solution with Co(NO₃)₂ and Al(NO₃)₃ in a molar ratio of Co²⁺/Al³⁺ of 2, where [M²⁺]=1.2 mol/L; Prepare NaOH solution in a ratio of n(NaOH)/[n(Co²⁺)+n(Al³⁺)]=1.8. Inject the mixed salt solution and alkali solution simultaneously into a rotating liquid film reactor for rapid nucleation. Capture the nucleation particles into the visible observation area through 6th sampling port on the side of the reactor from the top of the stator in a high-speed shear field using a micro negative pressure sampler. By capturing images with a high-speed camera, nucleation particles with a particle size >1 μm can be in situ observed. The results indicate that as the reaction time increases, amorphous aggregation further crystallize to form ordered nucleation particles.

### Example 3

A high-speed imaging system for monitoring a nucleation behavior of nanomaterials in a rotating liquid film reactor, as shown in FIG. 1, consists of a closed casing and a truncated cone with a narrow upper and wide lower structure and a bottom angle of 85° as the stator. The upper of the stator can be added with reactants according to the stoichiometric ratio, and there is a rotatable conical rotor inside the stator, which is connected to a motor below; At a speed of 1500 rpm and a slit width of 200 μm, a strong shear field is formed between the rotor and stator; At a distance of 30 mm from the top of the stator in the axial direction of the rotor-stator group, 8 sampling ports are set every 6 mm, and a micro negative pressure sampler is made to capture nucleation particles in a high-speed shear field into a visible observation area with a thickness of 2 mm, composed of polydimethylsiloxane glass, and a channel diameter of 50 μm in a methyl cross shape. The height is adjusted by a vertical lifting platform; Open a viewing window 2 with a diameter of 10 mm and a thickness of 1 mm on the other side of the rotor stator assembly. A high-speed camera (recording speed of 12000 frames per second) is connected in situ to a coupled microscope objective (10×) in two types of visual observation areas, with an LED white light source on the opposite side of the high-speed camera. Further connect it with a computer to drive the high-speed camera and the rotating liquid film reactor to work simultaneously.

The high-speed imaging system used to monitor the nucleation behavior of nanomaterials in a rotating liquid film reactor is applied to the preparation of cobalt based LDHs, and the specific operation is as follows:

Prepare a mixed nitrate solution with Co(NO₃)₂ and Al(NO₃)₃ in a molar ratio of Co²⁺/Al³⁺ of 2, where [M²⁺]=1.2 mol/L; Prepare NaOH solution in a ratio of n(NaOH)/[n(Co²⁺)+n(Al³⁺)]=1.8. Inject the mixed salt solution and alkali solution simultaneously into a rotating liquid film reactor for rapid nucleation. Capture the nucleation particles into the visible observation area through a viewing window. Nucleation particles with a particle size of 10 μm can be observed, showing that with the extension of reaction time, nucleation particles undergo secondary nucleation.

### Example 4

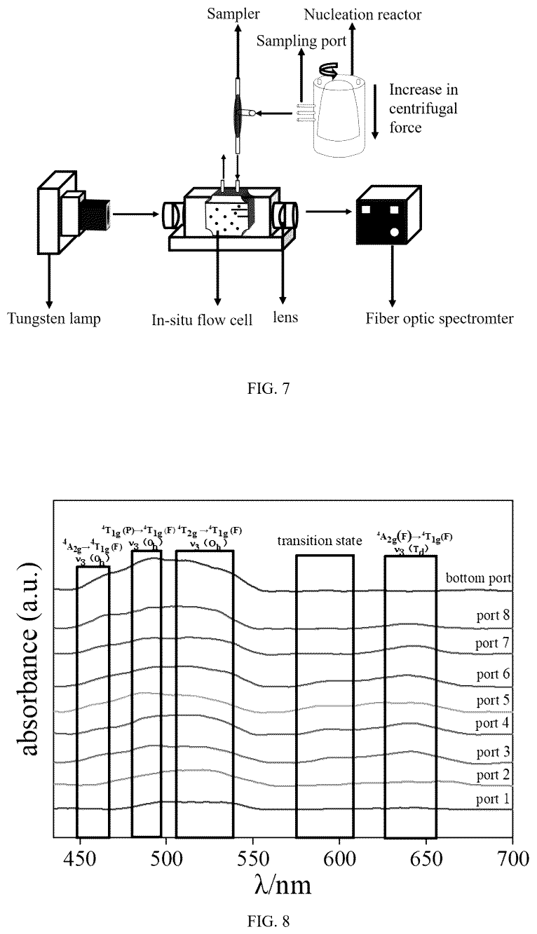

A time-resolved detection system for capturing the coordination structure of nucleation particles and the dynamic evolution behavior of intermediate species, shown in FIG. 7, consists of a closed casing and a truncated cone with a narrow upper and wide lower structure and a bottom angle of 85° as the stator. The upper of the stator can be added with reactants according to the stoichiometric ratio, and there is a rotatable conical rotor inside the stator, which is connected to a motor below; At a speed of 1500 rpm and a slit width of 200 μm, a strong shear field is formed between the rotor and stator; At a distance of 30 mm from the top of the stator in the axial direction of the rotor-stator group, 8 sampling ports are set every 6 mm, and in situ connected with flow cell made by quartz glass. The upper of the in-situ flow cell is connected to a halogen light source with a power of 40 W through a fiber optic cable with a core diameter of 600 μm and a transmission band of 200˜1200 nm, and the lower is connected to a fiber optic spectrometer with a CMOS detector and an integration time of 220 μs.

The time-resolved detection system for capturing the coordination structure of nucleation particles and the dynamic evolution behavior of intermediate species is applied to the preparation of cobalt based LDHs. The specific operation is as follows:

Prepare a mixed chloride solution by mixing CoCl₂ and AlCl₃ in a molar ratio of Co²⁺/Al³⁺ of 2, with [Co²⁺]=0.02 mol/L; Prepare NaOH solution in a ratio of [n(Co²⁺)+n(Al³⁺)]/n(NaOH)=½. Inject the mixed salt solution and alkali solution simultaneously into a rotating liquid film reactor for rapid nucleation at a nucleation speed of 1000 rpm, with a slit width of 200 μm between the rotor and stator, and a nucleation slurry concentration of 0.005 mol/L. Obtain the nucleation slurry through a vacuum sampler at sampling port 1 in the high-speed shear zone and enter in-situ flow cell at a flow rate of 50 mL/min. Obtain a UV visible spectrum with a time resolution of 435 μs through high-speed acquisition.

From FIG. 8, it can be seen that the nucleation slurry obtained from sampling port 1 only observed the v₃(Oₕ) characteristic vibration peak attributed to the transition from ⁴T_{1g}(P) to ⁴T_{1g}(F) and ⁴T_{2g} to ⁴T_{1g}(F) at 490-530 nm. However, the typical layer structure characteristic peak of LDH (460 nm) does not appear at this time, indicating that Co²⁺ initially coordinated with OH⁻ to form a [Co(OH)₆]⁴⁻ octahedral structure, but does not stack with [Al(OH)₆]³⁻ to form LDH layer.

### Example 5

Under the same conditions and parameters as in Example 4, experiments are conducted to obtain nucleating slurry through a vacuum sampler at sampling port 2 in the high-speed shear zone, which is then introduced into in-situ flow cell.

From FIG. 8, it can be seen that the v₃(Oₕ) characteristic vibration peak at 490˜530 nm in the nucleation slurry obtained from sampling port 2 is significantly enhanced, indicating a gradual increase in [Co(OH)₆]⁴⁻ octahedral unit cells.

### Example 6

Under the same conditions and parameters as in Example 4, experiments are conducted to obtain nucleating slurry through a vacuum sampler at sampling port 3 in the high-speed shear zone, which is then introduced into the in-situ flow cell.

From FIG. 8, it can be seen that the characteristic vibration peak of v₃(Oₕ) at 490˜530 nm in the nucleation slurry obtained from sampling port 3 continues to strengthen, while new characteristic peaks appear at 580 nm and 640 nm, respectively, belonging to the intermediate transition state of Co[(OH)ₓ(H₂O)₆]^{x-2} and the characteristic vibration peak of v₃(T_{d}) during the transition from ⁴A_{2g}(F) to ⁴T_{1g}(F). This is due to the instability of the intermediate, which is prone to dehydration and form tetrahedral coordination [Co(OH)₄]²⁻. In addition, a shoulder peak appears at 460 nm, indicating that the [Co(OH)₆]⁴⁻ octahedral and [Al(OH)₆]³⁻ octahedral crystal cells begin to stack.

### Example 7

Under the same conditions and parameters as in Example 4, experiments are conducted to obtain nucleating slurry through a vacuum sampler at sampling port 4 in the high-speed shear zone, which is then introduced into the in-situ flow cell.

From FIG. 8, it can be seen that the characteristic peak intensities of the nucleation slurry obtained from sampling port 4 slowly increase at 490˜530 nm, 580 nm, 640 nm, and 460 nm.

### Example 8

Under the same conditions and parameters as in Example 4, experiments are conducted to obtain nucleating slurry through a vacuum sampler at sampling port 6 in the high-speed shear zone, which is then introduced into the in-situ flow cell.

From FIG. 8, it can be seen that the characteristic peak intensities of the nucleation slurry obtained from sampling port 6 are significantly enhanced at 490˜530 nm, 580 nm, 640 nm, and 460 nm.

### Example 9

Under the same conditions and parameters as in Example 4, experiments are conducted to obtain nucleating slurry through a vacuum sampler at sampling port 8 in the high-speed shear zone, which is then introduced into the in-situ flow cell. From FIG. 8, it can be seen that the characteristic peak intensity of the intermediate transition state of the nucleation slurry obtained from sampling port 8 decreases at 580 nm and 640 nm, while the characteristic peak intensity continues to increase at 490˜530 nm and 460 nm, indicating that the intermediate transition state gradually transforms to form a Co—Al LDH.

### Example 10

Under the same conditions and parameters as in Example 4, experiments are conducted to obtain nucleating slurry through a vacuum sampler at the bottom outlet, which is then introduced into the in-situ flow cell.

From FIG. 8, it can be seen that the characteristic peak of the intermediate transition state of the nucleation slurry obtained from the bottom disappears completely at 580 nm and 640 nm, and the peak intensity reaches the highest at 490˜530 nm and 460 nm, indicating the formation of the characteristic layered structure of CoAl-LDH.

### Example 11

Experiments were conducted under the same conditions and parameters as in Example 4. A halogen light source with a power of 400 W is connected to a fiber optic with a core diameter of 600 μm and a transmission band of 200˜1200 nm to improve detection sensitivity. A fiber optic spectrometer with an integration time of 220 μs is connected to the lower end of the fiber optic spectrometer.

The time-resolved detection system for capturing the coordination structure of nucleation particles and the dynamic evolution behavior of intermediate species is applied to the preparation of cobalt based LDH, and the specific operation was the same as in Example 4.

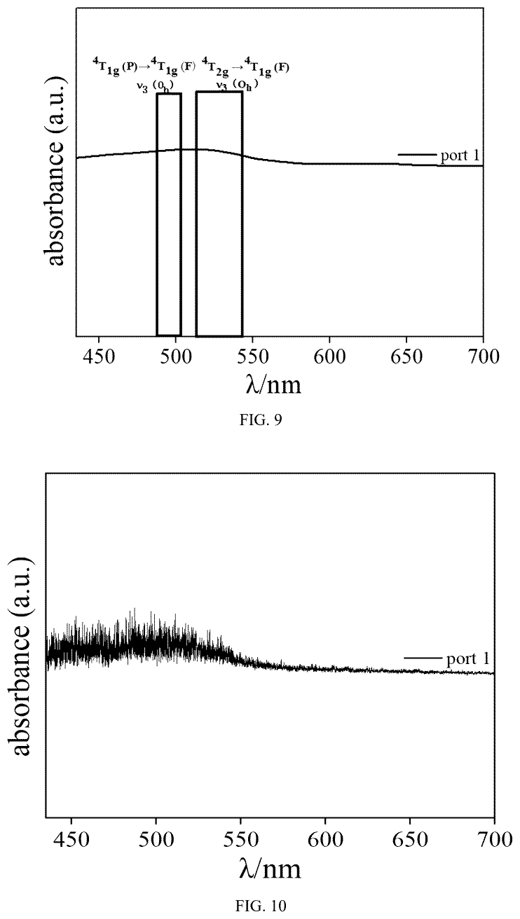

Compared with the spectrum obtained from port 1 in FIG. 8, the signal-to-noise ratio of the spectrum obtained using a 400 W halogen light source (FIG. 9) is significantly improved, and the peak positions are the same. Only the v₃(Oₕ) characteristic vibration peaks belonging to the transition from ⁴T_{1g}(P) to ⁴T_{1g}(F) and ⁴T_{2g} to ⁴T_{1g}(F) are observed at 490-530 nm, indicating that Co²⁺ first coordinates with OH⁻ to form the octahedral [Co(OH)₆]⁴⁻, and does not stack with [Al(OH)₆]³⁻ to form a LDH layer.

### Comparative Example 1

Experiments are conducted under the same conditions and parameters as in Example 4. A halogen light source with a power of 40 W is connected to a fiber optic cable with a core diameter of 50 μm and a transmission band of 200˜1200 nm. Nucleation slurry is obtained through a vacuum sampler at port 1 of the high-speed shear zone, which is then introduced into the in-situ flow cell.

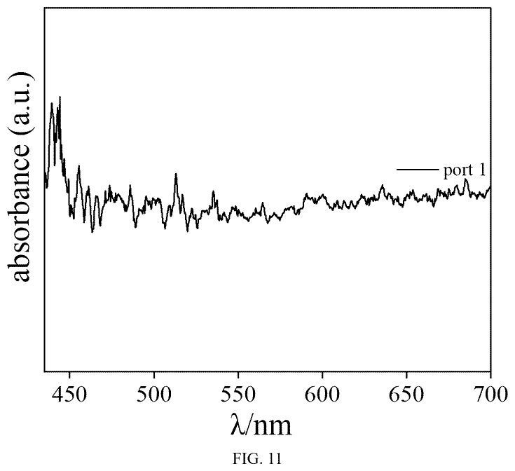

From FIG. 10, it can be seen that the spectrum obtained using a fiber with a core diameter of 50 μm does not show obvious characteristic peaks due to the low light flux.

### Comparative Example 2

Under the same conditions and parameters as in Example 4, experiments are conducted using a vacuum sampler to obtain nucleating slurry at sampling port 1, which is then introduced into the in-situ flow cell at a flow rate of 80 mL/min.

From FIG. 11, there is no obvious characteristic peak due to significant bubble interference.

What is claimed is:

1. An in-situ detection system involving multi measurements coupling with a nucleation reactor, comprising either one or both of a high-speed imaging system for monitoring a nucleation behavior of nanomaterials in a rotating liquid film reactor and a time-resolved detection system for capturing a coordination structure of nucleation particles and the dynamic evolution behavior of intermediate species; wherein
both high-speed imaging system and time-resolved detection system comprise a rotating micro liquid film reactor, which is composed of a closed casing as a stator, an upper end of the stator is filled with reaction solutions according to the stoichiometric ratio;
there is a rotatable rotor inside the stator, which forms a narrow slit with the stator with the width being 10˜500 μm, a shear field is formed between the rotor and stator;
an internal cavity of the stator is a circular cone with a narrow upper and wide lower structure, with a trapezoidal cross-section and a trapezoidal bottom angle design of 70˜85°; the stator height is 60˜80 mm, which could be moved up and down (Δh) to adjust the slit width; the rotor and stator structure are matched to maintain parallel sides when adjusting Δh; and
a hole that is connected to the motor shaft is set at the axial center to drive rotate at high speed once connecting to the electrode.

2. The in-situ detection system according to claim 1, wherein the rotor speed is 500˜5000 rpm; the stator cavity is a truncated and hollow cone with a narrow upper and wide lower structure with the top diameter of 42.3 mm, the bottom diameter of 51.5 mm, and the height of 75 mm; the cross section is trapezoidal, and the trapezoidal bottom angle is designed to be 85°; 8 sampling ports are set every 6 mm at a distance of 30 mm from the top of the stator.

3. The in-situ detection system according to claim 1, wherein the high-speed imaging system for monitoring a nucleation behavior of nanomaterials is equipped with a sampling port on one side of the stator sidewall of the rotating micro-liquid film reactor; a sampler is made to capture nucleation particles in the shear field and enter the visible observation area; open a viewing window on the other side of the stator sidewall; a high-speed camera with microscope lens is installed in the visual observation area or open window; a light source is installed on the opposite side of the high-speed camera, and the high-speed camera is connected to the computer to obtain the data.

4. The in-situ detection system according to claim 3, wherein the visible observation area is composed of two parallel stacked glass sheets with a thickness of 1˜3 mm, and there are micro scale channels with different shapes and diameters of 50˜100 μm between the two glass sheets; the glass material is one of polydimethylsiloxane, borosilicate, polystyrene, and polyurethane; the nanomaterials comprise hydrotalcite, oxides, hydroxides, pseudo boehmite, or barium sulfate.

5. The in-situ detection system according to claim 3, wherein the visible observation area is equipped with a vertical lifting platform, which could adjust the height; the high-speed camera records the images at a speed of 10000˜12000 frames per second, and is connected to a microscope lens with a magnification of 10˜50 times; the light source is white LED, a red LED, green LED, or a pulsed laser.

6. The in-situ detection system according to claim 1, wherein the time-resolved detection system for capturing the coordination structure of nucleation particles and the dynamic evolution behavior of intermediate species comprises a light source, an in-situ flow cell, optical fiber, vacuum sampler, optical fiber spectrometer, signal control and acquisition device; the sampling port of the rotating liquid film reactor is connected in situ to the flow cell; the upper end of the in-situ flow cell is connected to a light source through a fiber optic cable, and the lower end is connected to a fiber optic spectrometer, achieving the construction of time-resolved in-situ spectra with a resolution of less than 500 μs; metal salt solution and alkali solution are added into a rotating liquid film reactor for nucleation, and the nucleation slurry is captured into an in-situ flow cell through a vacuum sampler, and obtain the changes of coordination structure during the nucleation process through collecting a time-resolved spectrum of less than 500 μs; there is a convex lens at each end of the in-situ flow cell to form a symmetrical optical path.

7. The in-situ detection system according to claim 6, wherein the inlet is located at the top of the in-situ flow cell, and the outlet is at the bottom of it; the material of in-situ flow cell is one of borosilicate glass, quartz glass, or polymethyl methacrylate, with the light transmittance of over 92%; the focal length of the convex lens is 20 mm, and the clear aperture is 10 mm; the core diameter of the connecting fiber is 400˜600 μm, and the band is 200˜1200 nm; the light source with power 40˜400 W is one of xenon lamp, deuterium lamp, deuterium halogen lamp, or halogen lamp.

8. The in-situ detection system according to claim 6, wherein the fiber optic spectrometer has a CMOS detector with an integration time of less than 300 μs.

9. The in-situ detection system according to claim 1, wherein the molar concentration ratio of the metal salt solution to the alkali solution is 1/1˜3; the concentration of the nucleation slurry is 0.005˜0.01 mol/L; the flow rate of the nucleation slurry entering the in-situ flow cell is 50-80 mL/min.

10. An application of the in-situ detection system according to claim 1, wherein in-situ capturing the coordination structure, particle size, and dynamic behavior of reaction intermediates of nanoparticles in rotating liquid film reactor; the nanoparticles comprise hydrotalcite, oxide, hydroxide, pseudo boehmite, and barium sulfate.
